(19) United States
(12) Patent Application Publication
(10) Pub. No.: US 2010/0304086 A1
(43) Pub. Date: Dec. 2, 2010

(54) SUPER NON-WETTING, ANTI-FINGERPRINTING COATINGS FOR GLASS

(76) Inventors: Alain Robert Emile Carre, Le Chatelet-En-Brie (FR); Valerie Claudine Lacarriere, Larchant (FR)

Correspondence Address: CORNING INCORPORATED, SP-TI-3-1, CORNING, NY, 14831, US

(21) Appl. No.: 12/780,188

(22) Filed: May 14, 2010

Related U.S. Application Data
(60) Provisional application No. 61/182,159, filed on May 29, 2009.

(51) Int. Cl. B32B 3/00; B05D 1/38; B05D 5/00

(52) U.S. Cl. 428/149; 427/203; 977/773; 977/902

(57) ABSTRACT

Articles with surfaces that are both super-hydrophobic and super-oleophobic, and methods for making such articles are described. The article surfaces having contact angles of sessile drops of water and oil greater than 150° and low wetting angle hysteresis leading to low sliding angle of liquid water or oil drops. In some embodiments the water and oil contact angles are greater than 170°.

### CROSS-REFERENCE TO RELATED APPLICATIONS

This application claims the benefit of priority under 35 U.S.C. §119(e) of U.S. Provisional Application Ser. No. 61/182,159 filed on May 29, 2009.

### FIELD

The invention is directed to articles that have surfaces that are both super-hydrophobic and super-oleophobic, and to methods for making such articles.

### BACKGROUND

In recent years the market of cellphones, notebook computers and other portable electronic devices has been growing dramatically and much of this equipment has a touch-sensitive glass screen. While these touch-sensitive have great appeal to consumers, in use they begin to blur after they have been touched many times due to the deposition of fingerprint oils and dirt or dust. The problem is compounded when the consumer wipes the screens as a result of abrasion by the dirt or dust that is mixed with the fingerprint oils. When wiping is done the dirt or dust can abrade the screen. As a result there is a strong industry demand for anti-smudge coatings that could be applied on these screens. While coatings have been developed to reduce fingerprints or ease the removal of fingerprints (EP 933 377), these coatings have no real anti-smudge properties in the sense that they do not prevent fingerprints to be deposited on screens.

In parallel to the effort of reducing deposition of dust and dirt on solid surfaces, self-cleaning surfaces is becoming a subject of intense research. The development of super-hydrophobic, self-cleaning surfaces was first inspired by the observation of natural cleanliness of lotus leaves and other plant leaves. The key feature of the lotus leaf is a microscopically rough surface consisting of an array of randomly distributed micropapillae with diameters ranging from 5 to 20 μm. These micropapillae are covered with waxy hierarchical structures in the form of branch-like nanostructures with average diameters of about 125-200 nm. The water contact angle on a lotus leaf is higher than 160° with a rolling angle of about 2°, which is considered as a high performance super-hydrophobic surface. Water droplets coming in contact with a super-hydrophobic surface (contact angle)>150° form nearly spherical beads. Contaminants, either inorganic or organic, on such surfaces are picked up by water droplets or adhere to the water droplet and are removed from the surface when the water droplets roll off. The combination of low surface energy and micro- and/or nano-structured features, which can reduce the contact area between the surface and water droplets, form super-hydrophobic surface.

Several processes are described to render inorganic surfaces super-hydrophobic, meaning that the surfaces have a water contact angle>150°. For example, U.S. Pat. No. 6,652,669 reports that producing an ultra-phobic surface on an aluminum substrate by anodic oxidation of the aluminum followed by coating an approximately 50 nm-thick gold layer by atomization. Subsequently the gold layer of the sample is treated with a solution of n-decanethiol to form a surface that has a static contact angle for water of >150°; meaning that a drop of water of volume 10 μl rolls off if the surface is inclined by <10°.

WO98/23549 reports forming a substrate having anti-soiling and anti-mist properties. The substrate has a surface with bulges and hollows with submicron dimensions. The irregularities are created with inorganic particles of SiOC or TiO₂. A perfluorinated silane coated on the surface as a hydrophobic agent. The water contact angle may reach 145°, but this is not high enough to be considered as a super-hydrophobic surface) (>150°.

U.S. Pat. No. 6,800,354 claims a composition which provides a self-cleaning or hydrophobic coated substrate. The substrate is glass, ceramic, plastic or metal, or is a glazed or enameled coated substrate that is coated by a self-cleaning or hydrophobic coating that includes particles that form a surface structure on the coating. The coating includes a binder, formed from an organic or an inorganic material that operates to fix the particles to substrate surface. The structure forming particles have an average diameter of less than 100 nm. To create the desired high contact angle and/or low roll off angle, a hydrophobic layer is disposed on the structured substrate surface or layer, for example, by silanization. The water contact angle is above 150°, and the roll off angle is below about 1°. The phrase “self-cleaning” is generally synonymous with a contact angle or a low roll off angle in the above range.

U.S. Patent Application Publication Nos. 2006/0246297, 2006/0246277 and 2005/0170098 claim to make solid substrates, including glass, self-cleaning. Molten or heat softened particles of inorganic materials are deposited by a plasma spray onto the surface of a substrate to create a micro-rough surface. A hydrophobic top coating layer can optionally be applied to the micro-rough surface.

U.S. Pat. No. 6,997,018 reports a method of forming a glass article having a transparent hydrophobic surface during a glass-forming operation. Solid particles of inorganic materials having an average diameter of less than 400 nm are applied to a surface of the glass article when the glass article is at a temperature between 700° C. and 1200° C. The inorganic particles fuse to the surface of the glass article to form the transparent hydrophobic surface. A fluorosilane agent can be applied to the transparent hydrophobic surface to further increase its hydrophobicity. The transparent hydrophobic surface has a nano-structured texture, which makes the surface of the glass article very hydrophobic and easy to clean.

While a number of the surfaces reported in the above references are self-cleaning in the sense that water droplets tend to roll off the surfaces, contaminants, either inorganic or organic, on such surfaces are picked up by water droplets or adhere to the water droplet and are removed from the surface when the water droplets roll off.

A hydrophobic and oleophobic substrate is proposed in U.S. Patent application Publication No 2004/0067339. The outer surface of the substrate has the geometry of a sheet provided with protuberances, at least 80% of which have heights of between 40 and 250 nm and mean diameters of between 1 and 500 nm, and at least 80% of the distances between two neighboring protuberances ranges between 1 and 500 nm. In addition, a monolayer of perfluorooctylethyltrichlorosilane is grafted, under vacuum, by vapor phase onto the substrate. As an example, a plane surface characterized by advancing/receding angles of 100°/80° can be transformed to a surface containing protuberances and having angles of 160°/120°.

U.S. Patent Application Publication No. 2006/0110537 reports the formation of and anti-fingerprint coating composed of a hydrophobic nano-composite material, an oleophobic nano-composite material, and a super-amphiphobic nano-composite material. The contact angle between the super-hydrophobic material and the water is larger than 150 degrees. However, there is no clear description of the composites materials that can be used. Nothing indicates that the coatings have super-oleophobic properties, meaning a contact angle with oil greater than 150°.

While considerable progress has been made in the production of surfaces that are resistant fingerprint oils, smudging, hazing, and other items that degrade touch screen surfaces, considerable work still need to be done to develop a touch screen that has a long lifetime with little or no surface degradation. In particular, it is highly desirable to be able to make surfaces that are both super-hydrophobic and super-oleophobic, such surfaces having high contact angles of greater than 150° for both water and oil.

### SUMMARY

In one aspect the invention is directed articles with surfaces that are both super-hydrophobic and super-oleophobic, and to a methods for making such articles; such article surfaces having contact angles of sessile drops of water and oil greater than 150° and low wetting angle hysteresis leading to low sliding angle of liquid water or oil drops.

In another aspect the invention is directed to articles having a roughened glass surfaces with a silica nanostructure deposited thereon and a coating of a selected alkyl or perfluoroalkyl silane on top of said silica nanostructure roughened glass surface to thereby form a surface having super-hydrophobic and super-oleophobic properties, and to a method for making article with at least one surface having super-hydrophobic and super-oleophobic properties. The super-hydrophobic and super-oleophobic surface has a sessile water contact angle of >150° and a sessile sebaceous oil contact angle>150°. In one embodiment the sessile contact angle for both water and sebaceous oil is >160°. In another embodiment the sessile contact angle for both water and sebaceous oil is >170°.

In another aspect the invention is directed to the physical-chemical properties necessary to obtain a real anti-smudge coating with no fingerprint being transferred on substrates and the process developed to attain the objective. The desired properties, super-hydrophobicity and super-oleophobicity, are characterized by contact angles of sessile drops of water and oil greater than 150° and low wetting angle hysteresis leading to low sliding angle of liquid drops. These results are obtained by mixing micrometric roughness and nanometric roughness, and by treating the resulting surface with a perfluororinated silane. Double roughness structures help in amplifying the water contact angle and are appropriate surface geometries to develop “self-cleaning” surfaces. However, herein we demonstrate that the proposed double roughness structures also amplify the contact angle of liquids with much lower surface tensions than water, in particular with oils. This feature, i.e. a super non-wetting behavior (contact angle>150° with oils is called super-oleophobicity and is key to preventing fingerprint oil transfer from human fingers to a solid substrate.

In another aspect the invention discloses the mixing of micrometric (μm) and nanometric (nm) rms roughness on a glass substrate, followed by coating of the μm/nm roughened surface with a fluorinated silane, preferably a perfluorinated silane, in order to obtain super-hydrophobic and super-oleophobic properties leading to contact angles close to 180° with both water and oil. To get such high contact angles, the liquid drop must be in the so-called “Cassie-Baxter” situation in which the solid-liquid interface is composed of a small fraction x of true solid-liquid contact and of a fraction 1−x of liquid-trapped air interface. To get such very high contact angles, the micro-roughness has to be greater than 300 nm (rms roughness) and the nano-roughness is obtained from nanofilaments having a diameter in the range of 30-50 nm. The micrometric roughness can be obtained by grinding glass with a calibrated abrasive powder.

In one embodiment the invention is a glass article having a super-hydrophobic and super-oleophobic surface, said glass article comprising a glass substrate having a surface with a micro-roughness of ≧300 nm (rms), silica nanostructure particles deposited on the roughened glass surface and a selected perfluoroalkyl-Si coating on the micro-rough surface and nanostructure particles deposited thereon; the perfluoroalkyl-Si coating being bonded to the roughened glass and the silica nanostructure particles by 2-3 Si—O—Si bonds for each perfluoroalkyl-Si coating molecule. The selected perfluorocarbon-Si coating is selected from the group consisting of perfluoroalkyl-Si (R_{F}Si) and perfluoroalkyl(alkyl)-Si (R_{F}R₁—Si) coatings in which R_{F} is a C₈-C₂₀ perfluorocarbon and the R₁ alkyl is selected from the group consisting of methyl and ethyl. The R_{F} is selected from the group consisting of perfluorooctyl, perfluorodecyl, perfluorododecyl and perfluorotetradecyl perfluoroalkyls. The micro-roughness of the article is in the range of 300 nm (rms) to 1500 nm (rms). The silica nanostructure particles have a diameter in the range of 30-50 nm. The article has a super-hydrophobic water contact angle of greater than 150° and a super-oleophobic oil contact angle of greater than 150°. The article has a super-hydrophobic water contact angle of greater than 170° and a super-oleophobic oil contact angle of greater than 170°. The article has a water sliding angle of less than 10° (drop volume: 20 μl)

The invention is also directed to a method of making a glass article having a super-hydrophobic and super-oleophobic surface, the method comprising the steps of:

providing a glass substrate;

roughening the surface of the substrate to have a micro-roughness>300 nm (rms) by grinding the surface using a selected grinding material;

forming nanostructure particles on the surface of the micro-roughened glass with an alkyltrichlorosilane;

pyrolyzing the alkyltrichlorosilane nanostructure to form a silica nanostructure; and

coating the micro-rough and silica nanostructure with a perfluoroalkyl coating material selected from the group consisting of perfluoroalkyl(alkyl)dichlorosilanes [R_{F}R₁Cl₂Si], perfluoroalkyl(alkyl)dialkoxylsilanes[R_{F}R₁R₂Si], and perfluoroalkyltrialkoxysilanes [R_{F}(R₂)₃Si) where R_{F} is a selected perfluoroalkyl, R₁ is selected from the group consisting of methyl and ethyl, and R₂ is selected from the group consisting of methoxy and ethoxy. The selected perfluoroalkyl coating material is selected from the group consisting of perfluorodecyltrichlorosilane, perfluorododecyltrichlorosilane, pefluorotetradecyltrichlorosilane, perfluorooctyltrichlorosilane, perfluorodecyltrimethoxysilane, perfluorododecyltrimethoxysilane, perfluorotetradecyltrimethoxtsilane, perfluorooctyltrimethoxysilane, perfluorodecyltriethoxysilane, perfluorododecyltrimethoxysilane, perfluorotetradecyltriethoxysilane, perfluorooctyltrimethoxysilane, and perfluorodecylmethyldichlorosilane.

Forming nanostructure particles means forming particles having a diameter in the range of 30-50 nm.

### BRIEF DESCRIPTION OF THE DRAWINGS

FIGS. 1A and 1B illustrate a smooth glass surface with perfluorodecyltrichlorosilane (exact nomenclature name: 1H,1H,2H,2H-Perfluorodecyltrichlorosilane (abbreviation: “FDS’) coated nano filaments before (1A) and after (1B) wiping.

FIGS. 2A and 2B illustrate a rough glass surface (497 nm) with FDS coated nanofilaments before (2A) and after (2B) wiping.

FIG. 3 is a graph illustrating the rms roughness obtained has a linear relationship with the size of the microparticles used for grinding glass.

FIG. 4 is a schematic illustrating the treatment of a glass surface with methyltrichlorosilane (“MTCS”) to form MTCS nanofilaments on the glass surface.

FIG. 5 is a schematic illustrating the final micro- and nano-roughness of a glass substrate treated in accordance with the invention.

FIG. 6A is a SEM microphotograph showing a rough glass surface.

FIG. 6B is a SEM microphotograph showing FDS coated nanofilaments deposited on a rough glass surface.

FIG. 6C is a SEM microphotograph showing FDS coated nanofilaments deposited on a rough glass surface (cross-section).

FIG. 7 is a series of photographs illustrating the formation of fingerprints on untreated glass surface having roughness as indicated.

FIG. 8 is a series of photographs illustrating the formation of fingerprints on glass surfaces having roughness as indicated and FDS coated nanofilaments deposited on the rough glass

### DETAILED DESCRIPTION

The present invention is directed to surface coatings that are both super-hydrophobic and super-oleophobic (“SHSO” coatings), and to articles that have such on thereon. Herein is disclosed the mixing of micrometric and nanometric roughness on a glass substrate, followed by coating with fluorinated silane in order to obtain super-hydrophobic and super-oleophobic properties leading to contact angles close to 180° with both water and oil. To get such high contact angles, the liquid drop must be in the so-called “Cassie-Baxter” situation in which the solid-liquid interface is composed of a small fraction x of true solid—liquid contact and a fraction 1−x of liquid-trapped air interface.

To get such very high contact angles, the micro-roughness has to be greater than 300 nm (rms roughness) and the nano-roughness is obtained from nanofilaments having a diameter in the range of 30-50 nm. The micrometric roughness can be obtained by grinding glass with a calibrated abrasive powder. Nanometric roughness and super-hydrophobicity have been described by Seeger et al. in:
1. G. Artus et al and S. Seeger, “Silicone Nano filaments and Their Application as Superhydrophobic Coatings”, Advanced Materials, Vol. 18, No. 20 (2006), pp 2758-2762, 2006;
2. J. Zimmermann, G. Artus and S. Seeger, “Long term studies on the chemical stability of a superhydrophobic silicone nanofilament coating”, Applied Surface Science, Vol. 253, No. 14 (2007), pp 5972-5979;
3. J. Zimmerman et al and S. Seeger, “Long term environmental durability of a superhydrophobic silicone nanofilament coating”, Colloids and Surfaces A: Physicochemical and Engineering Aspects, Vol. 302, Nos. 1-3 (2007), pp 234-240;
4. J. Zimmermann, G. Artus and S. Seeger, “Superhydrophobic Silicone Nanofilament Coatings”, Journal of Adhesion Science and Technology, Vol. 22, Nos. 3-4 (2008), pp. 251-263; and
5. US Patent Application Publication No. 2007/0264437 titles “Superhydrophobic coating” (Seeger et al).
   However, it should be noted that the above processes described by Seeger et al. lead only to super-hydrophobic surfaces and not to surfaces that are both super-hydrophobic and super-oleophobic. Herein is described a method to make articles having surfaces that are both super-hydrophobic and super-oleophobic, and articles made using the method.

In accordance with the invention a glass surface is first roughened by grinding with an abrasive material having a selected particle size in order to achieve a selected degree of roughness. Examples without limitation of such abrasive materials include silicon carbide (“SiC”), corundum, alumina, diamond, cubic boron carbide and zirconia, and other abrasive materials known in the art. Silicon carbide is a preferred abrasive material. After the grinding is finished, the roughened glass surface is washed, for example by uses of an aqueous basic detergent solution and rinsing with deionized water. When the rinsing is finished the roughened glass surface is given a final cleaning by heating in air (pyrolysis) to a temperature in the range of 450-550° C. for a time in the range of 1-5 hours, preferably 2-4 hours, to remove any organic materials that may be present. After heating or pyrolysis is completed, methyltrichlorosilane (“MTCS”) filaments are formed on the roughened surface using vapor phase deposition. Table 1 shows the SiC particle sizes used to roughen glass and the glass roughness achieved with each size particles.

TABLE 1
SiC particle sizes and glass roughness

| SiC Particle | Glass roughness |
|---|---|
| Size (μm) | (rms) |
| 3 | 0.91 |
| 9 | 90.5 |
| 15.3 | 287.69 |
| 25.8 | 377.8 |
| 40.5 | 497.2 |
| 52.2 | 743.4 |
| 106.0 | 1477.0 |

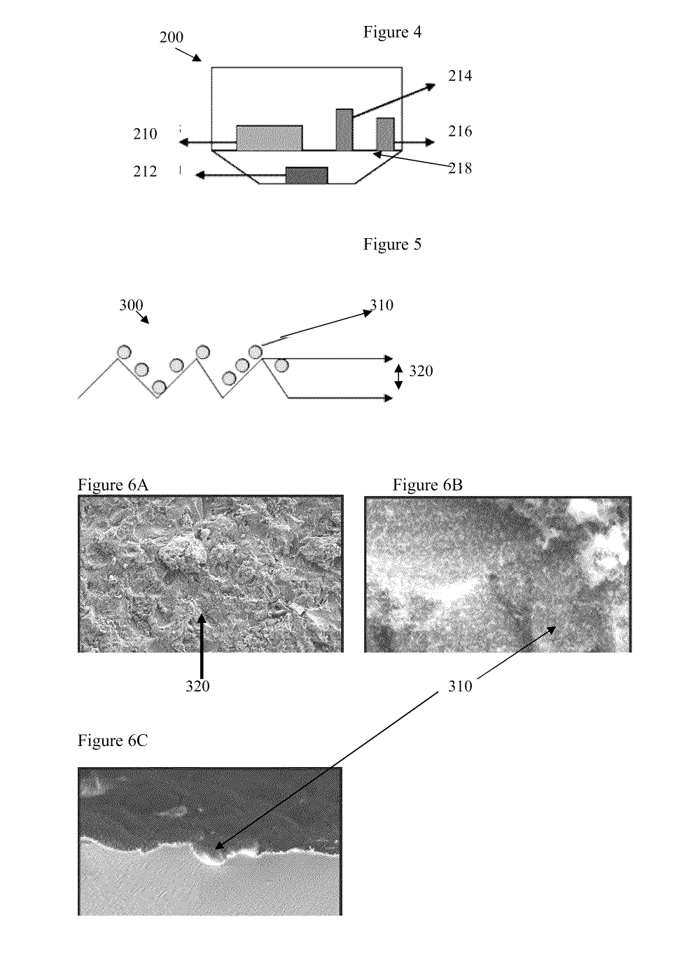

FIG. 4 illustrates a laboratory process for coating glass parts with methyltrichlorosilane (MTCS). The glass parts 210 were placed vessel 200 on shelf 218 that has openings therethrough. Also within the vessel 200 were placed an open container 214 of MTCS, a humidity control (small hygrometer introduced into the vessel 200) 216 and a saturated salt solution of NaI in a container situated below shelf 218. The vessel is closed under atmospheric pressure, then MTCS vaporizes from container 214 and is deposited on glass parts 210. The deposition was carried out from a time in the range of 1 to 1.5 hours at a temperature in the range of 20 to 25° C.

Once the MTCS nanostructures have been formed they are subsequently burned or pyrolyzed in an oxygen plasma for a time in the range of 1-5 minutes, generally approximately 2 minutes, to form a nanofilament silica (Si—O) skeleton (silica nano filaments) or framework. The surface of the glass, including the nano-silica skeleton, is then coated with a perfluoroalkyltrichlorosilane (R_{F}Cl₃Si) by vapor phase deposition at room temperature for a time in the range of 1-4 hours, preferably 1-2 hours. The deposition was carried out in a closed vessel under an inert atmosphere such as argon or nitrogen. The deposited perfluoroalkyltrichlorosilane (R_{F}Cl₃Si) is then hydrolyzed by exposure to moist air (humidity on the range of 25-80%, preferably 35-60%) at a temperature in the range of 18-40° C. for a time in the range of 1-5 hours. The hydrolysis step bonds the R_{F}Si— moiety to the silica nanofilament skeleton and the glass surface to thereby form a surface that is both super-hydrophobic and super-oleophobic.

While perfluoroalkyltrichlorosilane (R_{F}Cl₃Si) has been used herein as an exemplary material, other coating silane materials including perfluoroalkyl(alkyl)dichlorosilanes [R_{F}R₁Cl₂Si], perfluoroalkyl(alkyl)dialkoxylsilanes [R_{F}R₁R₂Si], and perfluoroalkyltrialkoxysilanes [R_{F}(R₂)₃Si) can also be used to coat the silica nanofilaments; wherein the perfluoroalkyl groups R_{F} are C₈-C₂₀ perfluoroalkyl groups, the alkyl groups R₁ are methyl and ethyl, and the alkoxy groups R₂ are methoxy and ethoxy. In some embodiments R_{F} is a C₈-C₁₄ perfluoroalkyl group. Thus, in addition to perfluorodecyltrichlorosilane, other exemplary silanes include, without limitation perfluorododecyltrichlorosilane, pefluorotetradecyltrichlorosilane, perfluorooctyltrichlorosilane, perfluorodecyltrimethoxysilane, perfluorododecyltrimethoxysilane, perfluorotetradecyltrimethoxtsilane, perfluorooctyltrimethoxysilane, perfluorodecyltriethoxysilane, perfluorododecyltrimethoxysilane, perfluorotetradecyltriethoxysilane, perfluorooctyltrimethoxysilane, and perfluorodecylmethyldichlorosilane. When the foregoing are fully bonded to the silica nanostructure, there are 2-3 Si—O—Si bonds, depending on the coating material that was chosen, and the species bonded to the silica nanostructure is a R_{F}—Si (3 Si O—Si bonds) or R_{F}R₁—Si (2 Si—O—Si bonds) moiety. According to the volatility of the perfluorosilanes, it may be desirable that they be heated to a temperature in the range of 40-100° C. to increase their vapor pressure. Optionally, a final “curing” step can be carried out after the coating can be deposited in order to insure that the perfluoroalkyl-Si moiety is fully bonded. The optional curing step can be done by using infrared or micro wave radiation.

As explained above, nanofilaments are formed on the roughened surface using methyltrichlorosilane and the nanofilaments are oxidized (either pyrolyzed or oxygen plasma treated) so that only a nanofilament silica skeleton is retained. As a result of this process the nanofilaments are embedded in the micrometric roughness of the substrate; that is the roughness that was obtained by grinding the surface with a selected abrasive material. Consequently, the nanostructure has a better durability with regard to wiping and abrasion. After the nanofilament structure has been formed the substrate was coated using a perfluoroalkyltrichlorosilane (for example without limitation, perfluorodecyltrichlorosilane (“FDS”) silane) in order to provide the super-hydrophobic and super-oleophobic properties necessary to avoid any fingerprint transfer onto the substrate. Other fluorinated silanes or silanes leading to hydrophobic coatings on a flat glass surface may be used as well.

Until the present invention, the coatings developed for anti-smudge properties were only leading to a decrease of fingerprint transfer or were hiding the fingerprints in the substrate roughness. As is shown by the data presented herein:
(a) it is possible to obtain a real anti-transfer coating that is both super-hydrophobic and super-oleophobic;
(b) the wettability properties necessary to obtain the anti-transfer behavior are measurable and translate to a contact angle close to 180° with water and oil; and
(c) a mix of nano- and micro-roughness on the glass substrate (in a defined range of values) is necessary to obtain contact angles close to 180°, especially with oil.

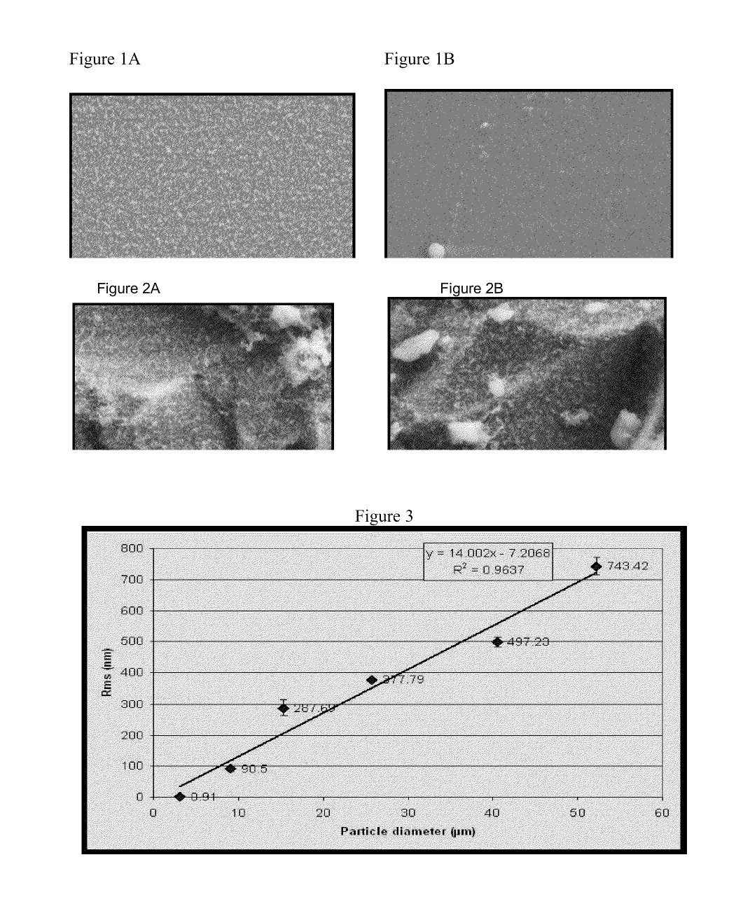

A further advantage of having a glass surface with a mixture of micro- and nano-roughness is that the nanofilaments are embedded in the micrometric roughness of glass. As a result, the abrasive resistance of the nanofilaments network is much better than the mechanical resistance of nanofilaments deposited on a smooth surface as described in the Seeger papers mentioned herein. A comparison of FIG. 1 (A and B) with FIG. 2 (A and B) shows that FDS coated nanofilaments are easily removed by wiping from smooth glass substrate, whereas the nanofilaments deposited onto the rough glass are preserved after wiping FIGS. 2A and 2B. In both FIGS. 1 and 2 (A and B) nanofilaments were formed on a smooth glass surface, pyrolyzed and then coated with FDS. FIG. 1A shows the FDS-coated nanostructure present on the smooth glass surface (the white dots) before wiping. The smooth glass surface was then wiped using a lens cleaning tissue (ref 1610E from Fischer). As shown in FIG. 1B the nanostructure has been essentially removed by the wiping. FIG. 2A shown a roughened glass surface (roughness=247 nm (rms)) having an FDS-coated silica nanostructure before wiping. The smooth glass surface was then wiped using a lens cleaning tissue. As shown in FIG. 2b the nanostructure remains after wiping and has not been removed.

FIG. 3 illustrates the glass micro-roughness that can be obtained by grinding with selected particle size abrasives, in this case SiC particles. The graph shows that the rms roughness is in a linear relationship with the size of the particles that were used in the grinding process. For example, grinding with approximately 10 μm particles gives an rms roughness of approximately 90 and grinding with approximately 40 μm particles gives an rms roughness of approximate 497.

FIG. 5 is diagram illustrating the final micro- and nano-roughness than are obtained on a glass surface 300 using the process as described herein. In FIG. 5 the glass micro-roughness is >320 nm mean height represented by the vertical double-headed arrow 320. The nanofilaments 310 have a diameter of ≦50 nm. The nanofilaments 310 can extend in any direction from the micro-rough surface.

FIG. 6A is a SEM micrograph of a roughened glass surface 320 (377 nm (rms)) before the deposition of any nanofilaments. FIGS. 6B and 6C are SEM micrographs of silica nanofilaments 310 coated with FDS. The nanofilaments were deposited in the micro-rough surface of the glass, pyrolyzed and coated with DDS.

Wettability measurements with water and sebaceous oil are made on samples to control that we effectively obtained super-hydrophobic and super-oleophobic properties. Measurements made on FDS coated rough glass, with no additional nanofilaments, show that the nanofilaments are necessary to obtain super-hydrophobic and super-oleophobic properties. The following Tables 2-5 illustrate the requirement to obtain a glass surface that is both super-hydrophobic and super-oleophobic.

Table 2 and 3, Column B, indicate that roughened glass surfaces without nanofilaments but coated with FDS have hydrophobic and oleophobic properties, but that the glass surfaces are not super-hydrophobic and super-oleophobic. The requirement for super-hydrophobic and super-oleophobic surfaces is that water and oil contact angles must be >150°. The contact angles shown in Column B are all <144°.

Table 2 and 3, Column C, also indicate that some roughened glass surfaces that have been coated with MTCS nanofilaments have super-hydrophobic properties. However, none of the glass surfaces in Column C are deemed to have oleophobic properties, and certainly do not have super-oleophobic properties. In all cases the contact angle with oil is <50°.

Tables 2 and 3, Column D, indicate that when silica nanofilaments are formed on a roughened glass surface, and the roughened surface and the nanofilaments are coated with a selected perfluorosilane as described here (fore example, perfluorodecyltrichlorosilane), the resulting coated product is both super-hydrophobic and super-oleophobic throughout the entire range of roughness from 0.91 nm (rms) to 1477.00 nm (rms). Super-hydrophobicity and super-oleophobicity are maximized when the surface roughness is in the range of 350 nm (rms) to 1500 nm (rms).

Tables 4 and 5, in which Columns A-D have the same meaning as in Tables 2-3, show the sliding angles for oil and water droplets on the various glass surfaces. Sliding angles, which provide information about wetting hysteresis [difference between the advancing and receding contact angle], are very low only for samples showing sessile contact angles close to 180°. Low hysteresis, indicated by a low sliding angle, is also evidence that there is a poor affinity of the liquid for the substrate and that the liquid will easily roll off from sample. Thus, the most desirable surfaces are those that have the lowest sliding angles. Column E in Tables 4 and 5 indicates the particle size of the silica used to indicate the roughness values shown in Column A.

Table 4 and 5, Column B, indicate that roughened glass surfaces without nanofilaments that have been coated with FDS generally have a water sliding angle of 25° or greater and an oil sliding angle of 30° or greater. While Column B glass surfaces are hydrophobic and oleophobic as in Tables 2 and 3, Column B, they are not super-hydrophobic and super-oleophobic, and they are at best low-performance hydrophobic and oleophobic surfaces since their water and oil sliding angles are generally 25° or greater.

Table 4 and 5, Column C, indicate that some roughened glass surfaces that have been coated with MTCS nanofilaments and can be considered as being high-performance surfaces in view of their having a water sliding angle of ≦10°. However, none of the surfaces in Column C have oleophobic properties and all have an oil sliding angle of >40°.

Tables 4 and 5, Column D, indicate that when silica nanofilaments are formed on a roughened glass surface, and the roughened surface and the nanofilaments are coated with a selected perfluorosilane as described here (fore example, perfluorodecyltrichlorosilane), the resulting coated product is both super-hydrophobic and super-oleophobic throughout the entire range of roughness from 0.91 nm (rms) to 1477.00 nm (rms). The surfaces than have a roughness of >350 nm (rms) are considered to be high performance super-hydrophobic surfaces because the water measured sliding angle is 0°. Two of the surfaces, roughness 753.42 nm (rms) and 144.00 nm (rms), are considered as being moderate performance super-oleophobic surfaces because they have sliding angles in the range of 10-15°. The 1477 nm (rms) surface is a high performance super-oleophobic surface that has an oil sliding angle of 5°.

TABLE 2
Sessile contact angle with water (4 μl droplet) *

| A | B | C | D |
|---|---|---|---|
| 0 (flat glass) ‡ | 110 | 151 | 150 |
| 0.91 | 107 | 147 | 153 |
| 90.5 | 103 | 150 | 157 |
| 287.69 | 114 | 153 | 163 |
| 287.69 | 120 | 156 | 159 |
| 377.39 | 122 | 122 | 180 |
| 497.23 | 138 | 138 | 180 |
| 743.42 | 140 | 140 | 180 |
| 1477.00 | 144 | 144 | 180 |

* = average sessile contact angle, precision ±3°
‡ = flat glass is glass that has not been roughened by grinding
A = mean glass roughness (rms)
B = contact angle in degrees, rough glass + FDS Coating
C = contact angle in degrees, rough glass + MTCS nanofilaments
D = contact angle in degrees, rough glass + FDS coated nanofilaments

TABLE 3
Sessile contact angle with sebaceous oil ((4 μl droplet) *

| A | B | C | D |
|---|---|---|---|
| 0 (flat glass) ‡ | 82 | No Oleophobic | 120 |
| 0.91 | 76 | Properties | 154 |
| 90.5 | 85 | Contact | 158 |
| 287.69 | 80 | Angle <50° | 154 |
| 287.69 | 96 | | 163 |
| 377.39 | 118 | | 175 |
| 497.23 | 121 | | 175 |
| 743.42 | 107 | | 160 |
| 1477.00 | 108 | | 175 |

* = average sessile contact angle, precision ±3°
‡ = flat glass is glass that has not been roughened by grinding
A = mean glass roughness (rms)
B = contact angle in degrees, rough glass + FDS Coating
C = contact angle in degrees, rough glass + MTCS nanofilaments
D = contact angle in degrees, rough glass + FDS coated nanofilaments

TABLE 4
Sliding Angles (SA) with water (20 μl droplet)

| E | A | B | C | D |
|---|---|---|---|---|
| 0 (flat glass) ‡ | 0 | 20 | 20 | 30 |
| 3 | 0.91 | 25 | 15 | 10 |
| 9 | 90.5 | 20 | 15 | 30 |
| 15.3 | 287.69 | 28 | 10 | 15 |
| 15.3 | 287.69 | 35 | 8 | 7 |
| 25.75 | 377.39 | 30 | 0 | 0 |
| 40.5 | 497.23 | 30 | 0 | 0 |
| 52.2 | 743.42 | 30 | 0 | 1 |
| 106 | 1477.00 | 37 | 0 | 2 |

* = average value, precision ±3°
‡ = flat glass is glass that has not been roughened by grinding
E = grinding material, SiC particle size (μm)
A = mean glass roughness (rms)
B = contact angle in degrees, rough glass + FDS Coating
C = contact angle in degrees, rough glass + MTCS nanofilaments
D = contact angle in degrees, rough glass + FDS coated nanofilaments

TABLE 5
Sliding Angles (SA) with sebaceous oil(20 μl droplet)

| A | B | C | D | E |
|---|---|---|---|---|
| 0 (flat glass) ‡ | 0 (flat glass) | 33 | >40 | 25 |
| 3 | 0.91 | 30 | >40 | 30 |
| 9 | 90.5 | 25 | >40 | 30 |
| 15.3 | 287.69 | 35 | >40 | 30 |
| 15.3 | 287.69 | 45 | >40 | 27 |
| 25.75 | 377.39 | 30 | >40 | 30 |
| 40.5 | 497.23 | 30 | >40 | 15 |
| 52.2 | 743.42 | 30 | >40 | 10 |
| 106 | 1477.00 | 30 | >40 | 5 |

* = average value, precision ±3°
‡ = flat glass is glass that has not been roughened by grinding
A = grinding material, SiC particle size (μm)
B = mean glass roughness (rms)
C = contact angle in degrees, rough glass + FDS Coating
D = contact angle in degrees, rough glass + MTCS nanofilaments
E = contact angle in degrees, rough glass + FDS coated nanofilaments

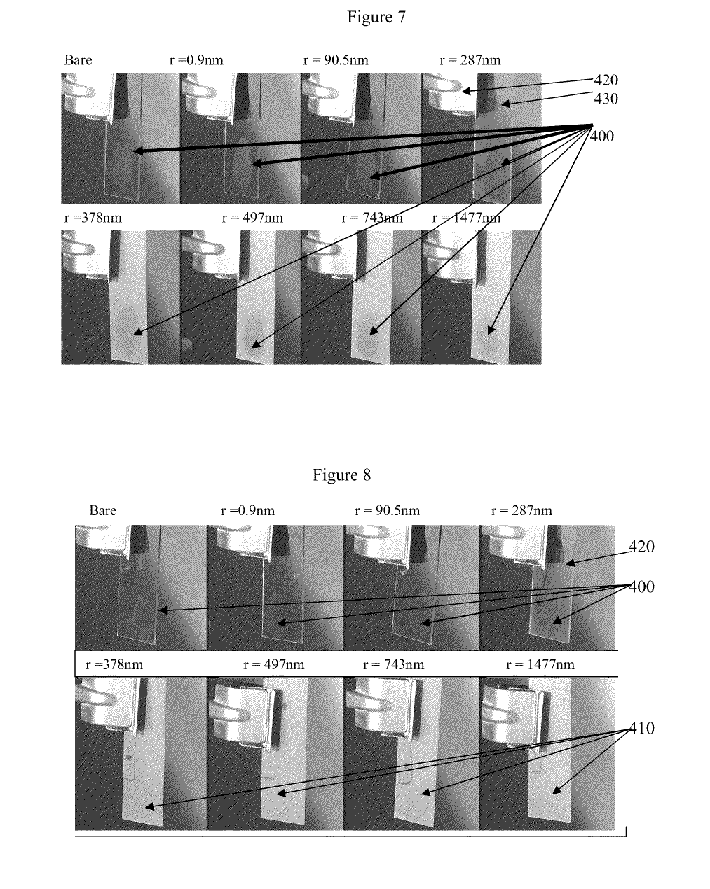

FIGS. 7 and 8 are photographs of actual fingerprint tests made using FDA coated roughened glass 420 having no silica nanofilaments (FIG. 7), and FDS coated roughened glass 420 having silica nanofilaments (FIG. 8). In both FIGS. 7 and 8 the “bare” glass sample is not roughened, has no filament structure and has no coating of any type applied to the surface. The glass is held by clamp 430 for photographing. The results of the fingerprint test show that no fingerprints were transferred to the onto samples that have contact angles near to 180° for both oil and water; that is, the samples of FIG. 8 that have a roughness>300 nm (rms). That is, samples that have a roughness of >300 nm (rms) and have silica nano filaments.

In order to validate the fingerprint test, in both sets of Figures the samples having a roughness>300 nm (rms) were dusted with graphite powder. In FIG. 7, fingerprints 400 were visible on all glass samples including those having a roughness of >300 nm (rms) regardless of roughness and regardless of whether the samples were graphite dusted or not graphite dusted. In FIG. 8, the bare glass sample and the samples having a rms roughness of <300 nm (that is, the samples of roughness 0.9 nm, 90.5 nm and 287 nm) all showed fingerprints 400 without the need for any graphite dusting However, no fingerprints were visible to the unaided eye for the glass samples having a rms roughness>300 nm (that is, the samples of roughness 378 nm, 497 nm, 743 nm and 1477 nm). In order to verify that there were no fingerprint on the >300 nm roughness samples of FIG. 8, these samples were dusted with the graphite powder. Arrow 410 in FIG. 8 shows that no fingerprints are visible after dusting for the FIG. 8 samples having a rms roughness>300 nm.

The test results thus indicate that fingerprints are visible on all glass substrates with no nanofilaments, regardless of the glass roughness. This demonstrates that micro-roughness only is not sufficient to obtain real anti-fingerprint properties. For the samples that have FDS coated nanofilaments on a rough glass substrate, the fingerprints were visible for a samples with a micro-roughness less than lower than 300 nm and were neither visible and nor revealed using graphite for sample having a micro-roughness greater than 300 nm. These results clearly demonstrate that the mix of micro- and nano-roughness is necessary to obtain anti-fingerprint properties. In addition, the results indicate that the micro-roughness has to be higher than 300 nm (rms).

Criteria for an Anti-Fingerprint Solid Surface

The interaction between a liquid and a solid surface can be assessed by measuring the contact angle of the liquid on the solid. The equilibrium of a liquid drop is described by the Young's equation:

γ_{SV}=γ_{SL}+γ cos θ

where γ_{SV} is the solid surface free energy in presence of the liquid vapor, γ_{SL} the solid-liquid interface free energy, γ the liquid surface free energy liquid surface tension), and θ the contact angle of the liquid on the solid. In the case of low surface free energy surfaces, as it is in the present context, the liquid vapor does not modify significantly the surface free energy of the solid, so that γ_{SV}=γ_{S}. The liquid-solid work of adhesion, W, which is the work necessary to separate the liquid from the solid along one interface area, is give by the Dupré's equation:

W=γ_{S}+γ−γ_{SL}.

Combining the Young and Dupré equations lead to the following expression of the liquid-solid work of adhesion according to the contact angle:

W=γ(1+cos θ).

From this last expression it can easily be deduced that a liquid will have no adhesion or zero adhesion to a solid surface if the contact angle is 180°. The practical implication of this is simple: the higher the contact angle, the lower the adhesion of the liquid on the solid surface.

However, the contact angle hysteresis is one complication that is often observed in describing the work of adhesion of a liquid on a solid. The contact angle measured with a sessile drop is between two extreme values: the advancing and the receding contact angles. The advancing contact angle, θₐ, is observed when the stationary liquid starts to advance across the solid surface, and the receding contact angle, θᵣ, is observed when the stationary liquid starts to recede across the solid surface. Low wetting hysteresis, (θ≈θₐ≈θᵣ) can be observed for some highly uniform solid surfaces with ultra-low surface energy. In some cases, super non-wetting surfaces may also have this type of feature, as has been mentioned for the case of water drops sliding on a lotus leaf. The ability to displace a liquid drop on a solid surface is directly linked to the contact angle hysteresis as has been described by A. Cane et al, “prop motion on an inclined plane and evaluation of hydrophobic treatments to glass,” J. Adhesion Vol. 49 (1995), page 117. Thus, in order to have a solid surface onto which it is not possible to transfer fingerprints, the contact angle of sebaceous oil (the model fingerprint oil commonly used in the art) must be high, close to 180°, and the contact angle hysteresis must be as low as possible (θₐ≈θᵣ≈180°). Some glass surfaces described in this invention meet these requirements, in particular those having a micrometric roughness of greater than or equal to 300 nm (≧300) and additionally have nanometric roughness provided by the nano filaments.

On a rough surface, the measured or apparent contact angle, θ, is different from the contact angle that can be obtained on the same material, but one having a perfectly smooth surface, θ_{Y}. The first attempt to understand the correlation between the surface roughness and apparent contact angle was made by R. N. Wenzel, Ind. Eng. Chem. Vol. 28 (1936), page 988. Wenzel noticed that the hydrophobicity of a material is enhanced by the presence of surface textures and attributed this behavior to the increase of the effective surface area. He introduced a dimensionless roughness factor, r, which is defined as the ratio of the actual surface area divided by its nominal (apparent) surface area. Assuming that water conformally fills the surface texture, he derived the equilibrium condition for the surface with a roughness r is being:

cos θ=r cos θ_{Y}

where θ is the apparent water contact angle in the so-called Wenzel state. This equation predicts that the water contact angle on a hydrophobic surface (θ_{Y}>90°) can be further increased by roughening the solid surface since the roughening increases r (r>1). For flat surfaces: r=1. As the surface roughness increases, it becomes difficult for the liquid to conformally fill the surface texture. This is easily predictable since a hydrophobic material has a higher surface energy when it is wet with water than when it is dry. In order to lower the surface energy, air can be trapped inside the texture. Since the contact angle of liquid on air is 180°, air entrapment will increase the hydrophobicity further. In this situation, the water drop is now viewed as sitting on a composite surface consisting of solid and air. At the minimum of surface energy and using Young's equation, the apparent contact angle for this case has been described by A.B.D. Cassie and S. Baxter [Trans. Faraday Soc., Vol. 40, (1946), page 546] as:

cos θ=x cos θ_{Y}−(1−x)

where x is the fraction of solid contacting the liquid. Increasing surface roughness decreases x which results in a large increase in θ. The consequence is a dramatically reduced work of adhesion of the liquid on the solid. Ultimately no liquid can be transfer to the solid substrate when the contact angle is close to 180°.

While typical embodiments have been set forth for the purpose of illustration, the foregoing description should not be deemed to be a limitation on the scope of the invention. Accordingly, various modifications, adaptations, and alternatives may occur to one skilled in the art without departing from the spirit and scope of the present invention.

We claim:

1. A glass article having a super-hydrophobic and super-oleophobic surface, said glass article comprising a glass substrate having a surface with a micro-roughness of ≧300 nm (rms), silica nanostructure particles deposited on the roughened glass surface and a selected perfluoroalkyl-Si coating on the micro-rough surface and nanostructure particles deposited thereon; the perfluoroalkyl-Si coating being bonded to the roughened glass and the silica nanostructure particles by 2-3 Si—O—Si bonds for each perfluoroalkyl-Si coating molecule.

2. The glass article according to claim 1, wherein the selected perfluorocarbon-Si coating is selected from the group consisting of perfluoroalkyl-Si (R_{F}Si) and perfluoroalkly(alkyl)-Si (R_{F}R₁—Si) coatings in which R_{F} is a C₈-C₂₀ perfluorocarbon and the R₁ alkyl is selected from the group consisting of methyl and ethyl.

3. The glass article according to claim 2, wherein R_{F} is selected from the group consisting of perfluorooctyl, perfluorodecyl, perfluorododecyl and perfluorotetradecyl perfluoroalkyls.

4. The glass article according to claim 1, wherein the micro-roughness of the article is in the range of 300 nm (rms) to 1500 nm (rms).

5. The glass article according to claim 1, wherein the silica nanostructure particles have a diameter in the range of 30-50 nm.

6. The glass article according to claim 1, wherein the article has a super-hydrophobic water contact angle of greater than 150° and a super-oleophobic oil contact angle of greater than 150°.

7. The glass article according to claim 1, wherein the article has a super-hydrophobic water contact angle of greater than 170° and a super-oleophobic oil contact angle of greater than 170°.

8. The glass article according to claim 1, wherein the article has a water sliding angle of less than 10°.

9. A method of making a glass article having a super-hydrophobic and sup-oleophobic surface, the method comprising the steps of:
providing a glass substrate;
roughening the surface of the substrate to have a micro-roughness>300 nm (rms) by grinding the surface using a selected grinding material;
forming nanostructure particles on the surface of the micro-roughened glass suing an alkyltrichlorosilane;
pyrolyzing the alkyltrichlorosilane nanostructure to form a silica nanostructure; and
coating the micro-rough and silica nanostructure with a perfluoroalkyl coating material selected from the group consisting of perfluoroalkyl(alkyl)dichlorosilanes [R_{F}R₁Cl₂Si], perfluoroalkyl(alkyl)dialkoxylsilanes [R_{F}R₁R₂Si], and perfluoroalkyltrialkoxysilanes [R_{F}(R₂)₃Si) where R_{F} is a selected perfluoroalkyl, R₁ is selected from the group consisting of methyl and ethyl, and R₂ is selected from the group consisting of methoxy and ethoxy.

10. The method according to claim 1, wherein the selected perfluoroalkyl coating material is selected from the group consisting of perfluorodecyltrichlorosilane, perfluorododecyltrichlorosilane, pefluorotetradecyltrichlorosilane, perfluorooctyltrichlorosilane, perfluorodecyltrimethoxysilane, perfluorododecyltrimethoxysilane, perfluorotetradecyltrimethoxtsilane, perfluorooctyltrimethoxysilane, perfluorodecyltriethoxysilane, perfluorododecyltrimethoxysilane, perfluorotetradecyltriethoxysilane, perfluorooctyltrimethoxysilane, and perfluorodecylmethyldichlorosilane.

11. The method according to claim 9, wherein forming nanostructure particles means forming particles having a diameter in the range of 30-50 nm.
